(19) United States
(12) Patent Application Publication
(10) Pub. No.: US 2003/0146159 A1
(43) Pub. Date: Aug. 7, 2003

(54) Method and apparatus to pack high efficiency columns for chromatography

(76) Inventor: Georges A. Guiochon, Knoxville, TN (US)

Correspondence Address: HOWARD EISENBERG, 1600 ODS TOWER, 601 S.W. SECOND AVENUE, PORTLAND, OR, 97204-3157, US

(21) Appl. No.: 10/068,174

(22) Filed: Feb. 6, 2002

(51) Int. Cl. B01D 15/08

(52) U.S. Cl. 210/656; 210/198.2

(57) ABSTRACT

Eliminating the friction between the packing material and the inner surface of a chromatographic column during the packing of the column provides a column that has a stationary phase that is substantially radially homogenous within the column. A preferred way to eliminate the friction is by vibrating the column in a direction substantially parallel to its long axis.

### FIELD OF THE INVENTION

The invention pertains to the fields of separation of a mixture and/or purification of a compound by column chromatography.

### BACKGROUND OF THE INVENTION

The most common method to separate and analyze a complex mixture of chemical compounds is by chromatography. In chromatography, a column is utilized that contains two components, a fluid called the “mobile phase” and a bed of fine particles called the “packing material” that contains the “stationary phase”. The mobile phase percolates through the column. A mixture of chemicals is introduced into the mobile phase at the column inlet, it is carried along the column by the mobile phase, and exits at the outlet port of the column. During this migration along the length of the column, the various chemicals in the mixture equilibrate between the mobile and stationary phases within the column. Actually, true equilibrium of the chemicals between the mobile and stationary phases is never completely achieved because a stream of mobile phase not containing the sample to be separated is continuously pumped into the column, pushing forward the zones of the mixture components. In the process, these zones separate and also broaden, until they reach the exit of the column.

The differing constants of equilibrium of the mixture components between the mobile and the stationary phases cause the different chemicals to migrate through the column at differing rates. The migration rate of the various chemicals in the sample to be separated is determined by two factors. The first is the velocity of the mobile phase which percolates through the column, carrying the chemicals with it. The second factor is the retarding force of the equilibrium between the mobile and the stationary phases. Molecules in the stationary phase cannot move. This retarding factor, which slows the migration of the chemicals in the sample along the column, is related to the affinity of the dissolved chemicals to the stationary phase. Because the chemicals in the mixture sample will have different equilibrium constants (should the stationary phase be properly selected) and because their migration rates are based on their differing equilibrium constants between the mobile and the stationary phases, the chemicals are separated as they emerge with the mobile phase from the outlet of the chromatography column.

Chromatography is used primarily for two purposes. It is the universal method used by modern chemists to separate and analyze complex mixtures. Analytical chromatography is highly efficient and rapid, requires small samples, and has become ubiquitous in laboratories wherever chemical, biochemical, clinical, or environmental analyses are performed. Most commonly, analytical chromatography is by high performance liquid chromatography (HPLC). This technique utilizes a tubular column, typically made of stainless steel or other strong, inert, non-porous materials such as a tough plastic material, having an outside diameter of typically up to about ¼ inch o.d. and being 10 to 30 cm long, and less commonly of up to ½ inch i.d. The material of which the column is made must be mechanically strong because columns for analytical chromatography are usually operated at high inlet pressures in order to achieve a significant fluid velocity across a long bed of small particles. This bed is made by packing the column with small particles constituting the packing material, which is generally a porous material such as silica, the surface of which may or may not be chemically or otherwise modified. Other packing materials, such as ion-exchange resins, alumina, and carbon, may also be used.

Because (1) packing columns is a tedious and time consuming operation; (2) most laboratories use chromatography for routine applications in which the reproducibility of column performance is of paramount importance; and (3) optimal performance of analytical columns requires that the bed be as homogeneous as possible, most analytical columns for chromatography are purchased pre-packed with beds of packing material.

The second use of chromatography is for the preparation of highly pure compounds by selective extraction from crude products and/or purification. This method is the primary method by which pharmaceutical companies produce purified chemicals for use as pharmaceuticals. Columns for preparative chromatography are typically between about 4 inches to 3 feet in diameter and give throughputs of between a few pounds and a few hundred tons per year. Preparative chromatography columns are typically packed for a production run or campaign, unpacked, and repacked with the needed solid phase by their users. Column skids, including ancillary equipment in order to pack and to operate the columns such as pumps, valves, tanks, and controllers, are sold to pharmaceutical companies for use in their applications of preparative chromatography.

Columns, both for analytical and for preparatory purposes, vary in their efficiency, which is one of the two parameters that characterize their ability to separate the constituents in a sample (the other being the differences between the equilibrium constants of the compounds of interest). Efficiency is often expressed in terms of the number (N) of theoretical plates in the column.

A theoretical plate is the length of a column that allows for one complete equilibration of the sample between the mobile and the stationary phases. Because the number of theoretical plates will vary according to the length (L) of a column and depending on the packing of the column, the concept referred to as the Height Equivalent to a Theoretical Plate (HETP) is used to compare the efficiency of two or more columns of the same or different lengths or to compare the same column under differing conditions. The HETP is defined as the ratio of the length of the column and the number of theoretical plates (N) of the column (HETP=L/N).

A higher separation efficiency of a column is associated with a higher N (number of theoretical plates) and a lower HETP. Therefore, it is clear that the separating efficiency of a column may be increased by increasing its length while maintaining a constant HETP, which would increase the number of theoretical plates. This, however, has the disadvantage of increasing the retention time of the sample in the column, of slowing down the separation, and of broadening the bands of compounds eluting at the exit of the column, which results in a deterioration of the detection sensitivity.

In order to avoid this and to maintain the length of the column constant, it is desirable to increase the number of theoretical plates. This is achieved by reducing the height of the theoretical plates, that is by having as small an HETP as possible.

One way to reduce the HETP is to reduce the size of the particles of packing material. Since the inception of HPLC, the conventional range of particle size (dₚ) of the packing materials used has decreased from about 80 microns to about 3 to 5 microns. However, there is a practical limit to this approach and particle sizes much smaller than 5 microns are not practical. This is because the efficiency of columns depends on the mobile phase flow velocity. Operating a column at a certain flow velocity requires the maintenance of a certain pressure at its inlet. Because the hydraulic resistance of a packed column increases in proportion to 1/dₚ², this pressure increases rapidly with decreasing particle size. The pressure required to operate current columns (packed with 5 micron particles) is in the range of several thousand p.s.i. Decreasing the particle size to 1.5 microns, which would multiply the separation efficiency by a factor of nearly 3, would require a pressure of 10,000 to 30,000 p.s.i., which would result in significant metal fatigue.

The other possible approach to increasing the efficiency of chromatography columns is to improve the quality of the bed of packing material. Packing quality is generally expressed in terms of the “reduced plate height” (h) which is the HETP of a column divided by the average particle size of the packing material that fills it, h=HETP/dₚ. Excellent presently available columns have minimum values of h of about 2.2 to 2.5 (at optimal velocity of the mobile phase through the column). Values of h around 2.0 are exceptional. Values below 2.0 have occasionally been published, but such results have proven difficult or impossible to reproduce. The reasons why efficiencies (h) less than 2 have been unobtainable is related to the methods by which chromatography columns are packed, which results in significant radial heterogeneity of the packed bed.

The oldest method of packing columns was by pouring into the column a dry packing material while radially vibrating the column to prevent aggregation of the particles. The efficiency of the particle beds produced by this method of dry packing tended to be poor due primarily to radial size-discrimination. This would occur due to the fact that larger particles fall faster along the slope of the rising cone of packing material that is produced when the packing material is poured into the column. Also, the larger particles move farther away from the center of the cone than do smaller particles when the column is radially vibrated. This radial heterogeneity of dry-packed columns results in an increased velocity of the mobile phase in the region of the column adjacent to the wall compared to that in the core region. It is evident that the varying velocities of different portions of the mobile phase causes a decreased efficiency of separation.

A second method of packing chromatography columns, referred to as slurry filtration, is utilized for the preparation of analytical columns. Columns packed in this way are generally between about ⅛ inch or ¼ inch o.d., although microbore or narrow bore columns having an i.d. below 1 mm, even as low as 10 micron, are packed in this manner. Also, laboratory preparative or semi-preparative columns of ½ to 4 inches i.d. or even larger may also be packed by slurry filtration.

In slurry filtration, one end of a column is closed by a frit. At the other end, a slurry suspension of the packing material is pumped into the column tube. A filtration cake builds up against the frit and grows until the tube is filled, forming a bed of the packing material. This bed is consolidated by percolating a number of column volumes (ca 10 to 20) of a packing solvent which is miscible with the slurry suspension fluid, and which may or may not be different from this slurry suspension fluid, at a high flow rate with an inlet pressure of the order of 10,000 p.s.i. The consolidation takes place under the influence of the seepage force, that is the reaction of the bed to the pressure gradient required to maintain the flow rate of the stream of liquid percolating through the bed.

The slurry filtration method has the disadvantage that beds of packing material produced in this manner are radially heterogeneous. The bed is denser close to the wall than it is in the core region. Consequently, the mobile phase migrates faster in the core region than in the wall region and the band becomes warped. Because detection is made on the bulk fluid leaving the column, there are no possibilities to correct for this radial distribution of the concentration and the band appears wider than it is really.

Standard methods of slurry filtration are generally not suitable for the wide bore columns used in preparative chromatography. If packed by slurry filtration, the beds of wide bore columns tend to collapse in places with the formation of pools of free liquid at the column inlet. Convection in these pools causes backmixing and a drastic decrease of the column efficiency. To remedy this problem, mechanical compression is used. Two types of compression are used, axial compression (compression of the slurry in a direction parallel to the walls of the column) and radial compression (compression of the slurry in the radial direction, i.e., in a centripetal fashion).

In dynamic axial compression (DAC) of the slurry, a column skid functions like a syringe, with a piston (with leakproof fittings on the side) sliding along the interior of the column tube. The piston is actuated by a jack of appropriate power. The mobile phase enters through the piston head which is covered by a frit and which contains a flow distributor. To pack the column, the piston being in its extreme position (all column volume accessible), the column is filled with an appropriate volume of slurry (usually about one part of packing material to two parts of solvent). Then the column is closed by bolting a head to the column open end. This head contains a flow distributor and a frit. The piston is moved by the jack, compressing the slurry against the head. Typically, the feed line bringing the mobile phase to the column is closed and the feed line carrying it from the column end is open. Then, the slurry solvent is pushed out of the column while the packing material is filtered into a cake that becomes the bed. This bed is consolidated under the mechanical stress conveyed by the jack. This stress is adjusted to obtain a dense, stable bed without breaking more than a few particles. Under such conditions, no void can form anywhere in the column.

In radial compression of the column, the slurry is introduced in a rubber bladder or, in the only implementation available now, in a flexible-wall prepacked cartridge which is placed inside a steel chamber. The cartridge is compressed radially by injecting a pressurized liquid between the steel and the plastic walls. Suitable fittings ensure leak proof insulation between the pressurizing fluid and the mobile phase which enters and exits the cartridge through its ends. Typical compression pressures are between 100 and 200 psi. The cartridges are prepacked by the slurry filtration method but consolidated only at moderate flow rates to avoid the use of a high pressure that would cause the cartridge to burst. For this reason the initial cartridge bed is radially inhomogeneous. Furthermore, radial compression does not provide a radially homogenous distribution of stress and strain inside a bed of particulate material because stress in beds of particulate matter does not convey everywhere equally as pressure does in liquids. The friction between particles and the compressibility of the bed combine to cause a gradient of stress, the latter decreasing from the wall to the center of the bed.

In each of these methods, the bed of packing material is heterogenous in both the axial and radial directions. Axial heterogeneity has only a minor effect on column efficiency. It causes a systematic deviation from linear behavior of the pressure gradient of the mobile phase along the column, but no significant change in the mobile phase velocity because the compressibility of liquids is practically negligible in the range of pressures used in HPLC.

In contrast, radial heterogeneity has a drastic effect on column efficiency. Radial heterogeneity, as produced by slurry methods of packing, causes a warping of the bands as they travel through the column. This warping is in the shape of an upward bowl, the edge of which is closest to the column walls, so that the portion of the bands closest to the walls exits later than the portion of the bands in the center of the column. For this reason bands eluted from the column appear wider, less symmetrical and less well resolved than they would be on a radially homogeneous column, having otherwise the same properties.

The cause of this radial heterogeneity is the friction of the bed of particles against the column wall. This conclusion is confirmed by others and by my laboratory using various methods of optical visualization. D. Train, J. Pharm. and Pharmacol., 8:745 (1956); D. Train, Trans. Instn. Chem. Engrs., 35:258 (1957); Yun, T., and Guiochon, G., Visualization of the Heterogeneity of a Column Bed, J. Chromatography A, 760:17-24 (1997). The importance of the friction between the bed and the column wall was established by measuring it, which was done by using a DAC column and measuring the mechanical stress required to force the bed to start moving out of the column. Guiochon, G., et al., Evidence of a Wall Friction Effect in the Consolidation of Beds of Packing Materials in Chromatographic Columns, J. Chromatography A, 835:41-58 (1999); Cherrak, D E, and Guiochon, G., Phenomenological Study of the Bed/Wall Friction in Axially Compressed Packed Chromatographic Columns, J. Chromatography A, 911:147-166 (2001). Finally, the modeling of the rheological behavior of a bed of slurry during its consolidation demonstrated that friction is a consequence of the consolidation of the bed. Yew, G Y, et al., Application of the Rheology of Particulate Materials to the Study of the Properties of Column Beds. I—Acquisition of the Relevant Parameters, In Press; and Yew, G Y, et al., Application of the Rheology of Particulate Materials to the Study of the Properties of Column Beds. II—Modeling of the Stress, In Press.

Any increase in the efficiency of chromatography columns would provide a corresponding decrease in the time required to perform the separation of any mixture, a saving that could be most important in the case of complex mixtures of chemical compounds since these separations require high column efficiencies. A halving of the reduced HETP of a column, for example to 1.2 to 1.5, would therefore result in a substantial savings (about 40%) in both the time and money required for either the analysis of mixtures or for the preparation of purified chemicals, savings that would be especially important in the field of pharmaceuticals.

### SUMMARY OF THE INVENTION

In one embodiment, the invention is a method for packing a chromatographic column in which the column is loaded with a packing material, such as in the form of a slurry, and the column is vibrated in a direction substantially parallel to the long axis of the column.

In another embodiment, the invention is a method for reducing the friction between the interior surface of a chromatographic column and a bed of packing material contained within the column. According to this embodiment, the column containing the slurry is axially vibrated, thereby reducing the friction.

In another embodiment, the invention is a packed chromatographic column in which the reduced HETP is determined to be less than 2.

In another embodiment, the invention is a packed chromatography column which contains within a bed of packing material that is substantially radially homogenous within the column.

In another embodiment, the invention is a chromatographic column that has been packed according to the method of the invention for packing chromatographic columns.

In another embodiment, the invention is a method for separating one or more compounds from a mixture of compounds. According to this embodiment, the mixture is inserted into one end of a chromatographic column in which the packing material has been slurry packed in the column while being axially vibrated and the separated compounds from the mixture are made to travel along the length of the chromatographic column to exit out the opposite end of the chromatographic column.

In another embodiment, the invention is an apparatus for axially vibrating a chromatographic column. According to this embodiment, the apparatus includes a holder for the chromatographic column and a vibration mechanism that oscillates the column in a vertical direction wherein the holder maintains the long-axis of the column in a substantially vertical position during the vertical oscillations.

In another embodiment, the invention is an apparatus for packing a chromatographic column. According to this embodiment, the apparatus includes a holder for a chromatographic column that maintains vertically the long-axis of the chromatography column, a vibration mechanism that vertically oscillates the column, and a means to introduce a slurry of packing material into the column. The apparatus may further include a compression means for compressing the packing material within the column.

### BRIEF DESCRIPTION OF THE FIGURES

FIG. 1 shows a diagrammatic representation of a preferred embodiment of the apparatus of the invention for axially vibrating and/or packing a chromatographic column.

FIG. 2 shows a diagrammatic representation of an alternate preferred embodiment of the apparatus of the invention for axially vibrating and/or packing a chromatographic column.

FIG. 3 is a graph showing the reduced HETP (h) of an unretained tracer against the reduced velocity of the mobile phase in a column packed according to the prior art and in three columns packed according to the method of the invention.

FIG. 4 is a graph showing reduced HETP (h) of a retained compound against the reduced velocity of the mobile phase in a column packed according to the prior art and in three columns packed according to the method of the invention.

### DETAILED DESCRIPTION OF THE INVENTION

It has been discovered that, by essentially eliminating friction between the inner wall of a chromatographic column and the monolayer of the packing material that is in contact with this wall during the packing process, a radially homogenous distribution of packing material within the column may be obtained. Such a radially homogeneous column provides narrower bands of the eluates leaving the column, with a resultant significant increase in the separation efficiency of the column. By eliminating the wall friction during the packing operation, HETP values as low as 1.5 and even as low as 1 may be obtained. It is further conceived that HETP lower than 1 may be obtained by completely eliminating this friction.

According to the method of the invention, a chromatography column is vibrated in a direction substantially parallel to its long axis during the packing process. The vibrations essentially eliminate the friction between the packing material and the inner wall of the column, which friction is the primary cause of the radial heterogeneity of the distribution of the density of the packing material in the column. The elimination of this friction permits one to obtain a chromatographic column that has an essentially homogenous radial distribution of its packing material. This homogeneity significantly reduces or eliminates the artifactual widening of the bands due to the differing velocities of the mobile phase through regions of the column having different packing densities.

The method of the invention is applicable to chromatographic columns made of any suitable material, such as a metals like stainless steel, aluminum, or copper, or a rigid plastic. The column must, of course, be able to withstand the stresses sustained due to the vibrations and the pressure of the mobile phase pumped through the column. The method of the invention is applicable to any packing material used in analytical or preparative chromatography.

When packing a preparative chromatography column, typically an axial compression device, such as a piston, is used. According to a preferred embodiment of the method of the invention, the piston is withdrawn sufficiently and the desired volume of a slurry of the packing material in an appropriate solvent is introduced into the column. The end of the column is closed. The column is then vibrated, during which time the piston or compression device is moved to compress the slurry, to filter out the excess solvent contained in the slurry, and to compact the packing material in order to provide a homogenous, stable, and compact bed. The vibrations are then stopped.

When packing an analytical chromatography column, typically no compression device is used. According to a preferred embodiment of the method of the invention, the column is filled with a suitable slurry solvent, closed with a frit retaining all the particles of packing material, and a stream of a slurry of the packing material in said slurry solvent is pumped into the column. Preferably, before the slurry begins to be pumped into the column and during the whole packing operation, the column is vibrated. When a sufficient amount of slurry has been pumped into the column and the column is filled, a suitable packing solvent (identical to or different from the slurry solvent, as most convenient) is percolated through the column, during which time the column remains vibrated. The packing operation is finished when a sufficient volume of packing solvent, typically a few to 50 column volumes, has been percolated through the column. The solvent percolation and the vibrations are stopped. The column is provided with a homogenous, stable and compact bed.

Whether a column is packed by slurry compression or slurry filtration, the vibration of the column begins preferably before starting the process of consolidation of the bed of packing material or nearly at the same time. Axial vibrations of the column reduce considerably the friction of the bed against the column wall and this allows the bed to slide smoothly along the wall without being perturbed by friction. Following the filling of the column, the column is closed and vibrations are stopped. Then friction resumes between the column wall and the homogeneous bed, ensuring leakproof contact between the bed and the wall and preventing the mobile phase stream from bypassing the bed. Vibration times longer than stated above may be used if desired. Vibration times shorter than stated above may be used if desired, but may produce less than optimal results.

Frequency and amplitude of the vibrations are selected so as to provide an elimination of friction between the packing material and the wall of the tube. At a given amplitude, an increase in the frequency will result in a more complete elimination of this friction. Above a certain frequency, of course, the friction will be totally eliminated and further increases in frequency will not further increase the effectiveness of the method. The same relationship is true for the amplitude. At a given frequency, an increase in the vibration amplitude will result in a more complete elimination of the friction. Above a certain amplitude, friction will be totally eliminated and further increases in amplitude will not further increase the effectiveness of the method. Too high a vibration energy will result in particle breakage, a phenomenon that is adverse to column performance. A compromise may be necessary when packing brittle packing materials. The optimum vibration energy may depend on the characteristics of the column tubing, the packing material, and the solvents used.

Generally, a frequency of vibration between 60 and 120 Hz is preferred, preferably between about 90 to 100 Hz. However, lower or higher frequencies may be used so long as the combination of frequency and amplitude causes a sufficient reduction of the friction between the packing material and the wall of the tube. It is conceived that frequencies as low as 1 Hz or lower and as high as 1000 Hz or higher may be used in accordance with the invention, if desired, and depending upon the vibration amplitude employed.

Generally, an amplitude of vibration between 1 and 10 mm coupled with a frequency of vibration between 60 and 100 Hz is preferred. At these frequencies, amplitude is most preferably between 2 and 6 mm. If desired, however, amplitude may be higher or lower than these values. Depending on variables such as size and construction of the column and frequency of vibration, an appropriate amplitude of vibration is selected.

According to the invention, the packing material in the column could be dry (if columns for gas chromatography are packed) or wet (if HPLC columns are packed) when vibrated. When packing an HPLC column, it is preferred that the packing material be introduced into the column as a slurry. If desired, the packing material could be dry when introduced into the column and then wetted, such as by the introduction of one or more column volumes of a solvent, before vibration. The use of dry packing material is not preferred, however, because the addition of solvent during the packing process or, more importantly, after the consolidation is over tends to compress further this packing material with resultant shrinkage of the packing bed, allowing friction to perturb the bed. If dry packing is used, it is preferred to introduce the dry packing material into the column and to then introduce a wetting solvent before or during the vibration of the column.

If desired, the method of the invention may be used in conjunction with other methods that have been employed, or may be employed in the future, to increase, or attempt to increase, the efficiency of chromatography columns. Thus, for example, the method of the invention may be and was used, as described below, in conjunction with axial compression methods such as DAC. It could also be used to prepare the prepacked cartridges used with radial compression columns. Radial vibration, that is vibrations of the column in a direction perpendicular to the long axis of the column is not preferred, however, as it tends to have the negative effect of radially segregating the particles of the packing material, contributing to cause a heterogeneous radial or transverse distribution of the mobile phase velocity.

According to one embodiment of the apparatus of the invention for axially vibrating a chromatography column, the apparatus includes a holder for supporting the chromatographic column in a vertical position and a vibrator which is operationally or directly connected to the holder and which vertically vibrates the column while it is maintained in position by the holder.

An example of a holder that is suitable for the apparatus of the invention is a base, such as a one-legged or multi-legged support, such as a tripod, and one or more horizontally extending support arms. Another suitable example is a tube assembly having a tube which is vertically oriented and into which a chromatographic column may be positioned.

The vibrator may be an integral portion of the holder. For example, a vertically oriented portion of the holder may include a piston assembly, rotating cam, or magnetostriction device that moves the column-holding portion of the holder in an oscillating vertical manner. Alternatively, the vibrator may be an element distinct from the holder itself.

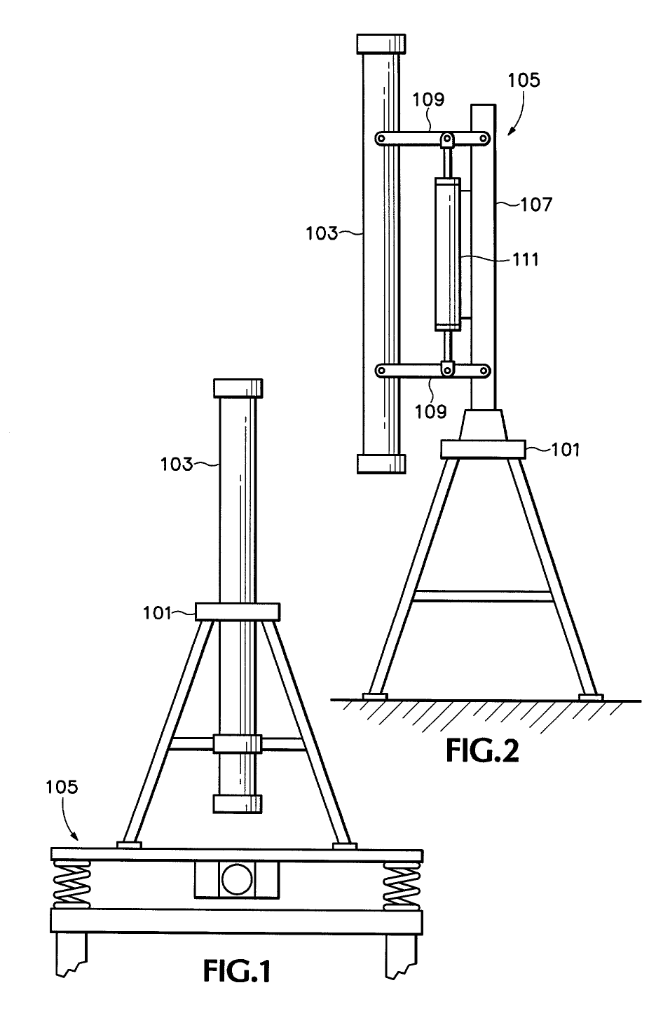

As shown in FIG. 1, the apparatus of the invention for axially vibrating a chromatographic column contains a chromatographic column holder 101 that holds the column 103 and maintains the column in position so that its long-axis is substantially vertical. The holder is operationally or directly connected to an oscillator 105 that produces vibratory oscillations of the column in a vertical direction. As shown in FIG. 1, the oscillator 105 may be a vibrating table or stand upon which the holder is fastened.

FIG. 2 shows an alternate embodiment of the apparatus in which the oscillator 105 is part of the holder 101. In this embodiment, the holder includes a stationary portion 107 that supports a mobile portion 109 that in turn supports a column 103. The mobile portion 109, shown as a pivot but which may be otherwise such as a collar assembly, vertically oscillates the column as a piston assembly 111 moves the mobile portion 109 relative to the stationary portion 107.

The invention is illustrated by the following non-limiting examples.

### EXAMPLE 1

An LC-50.VE.500.100 DAC Column Skid from Prochrom (Champigneulles, France), now NOVASEP (Gibbstown, N.J.), with a total weight of about 100 pounds (45 kg) was used in the following studies. The skid includes a column assembly with its piston and top head, a compression unit, and a skid frame. A pump for the mobile phase, a feed injection device and a detector complete the HPLC unit. The column is a cylinder of stainless steel (5.0×59.0 cm), with outer grooves at 15 degree angles and an inside cone at 10 degree angles at both ends. The maximum working pressure of this column is rated at 100 bar. The compression unit includes a Haskel (Burbank, Calif.) pump, a pump oil reservoir, a three-way hydraulic valve and a hydraulic jack, all components being housed in the four legged skid. The Haskel pump drives the hydraulic jack and is assisted by compressed air from a cylinder. The upward or downward movement of the hydraulic jack is controlled by the three-way distribution valve which directs the oil flow. The piston is connected to the jack. The piston head contains a sample distributor and the inlet frit. It is connected to a tubing for the incoming mobile phase. The outer layer of the piston head contains chevron V-seals for proper sealing. The top head of the column is fitted to the top flange and contains a sample distributor, the outlet frit and an O-ring for proper sealing of the frit against the column wall.

This skid was bolted to the top surface of a vibrating table obtained from St. Louis Vibrator Products (St. Louis, Mo.). The hydraulic pump of the jack and its rigidly connected valve that were on the equipment as it came from the manufacturer were removed from the skid and the rigid hoses and lines were replaced with high pressure flexible tubing so as to enable these connections to withstand the stresses introduced during the vibration process.

Four nearly identical LC-50 columns were successively packed to a height of approximately 16 cm with the same amount of a slurry prepared with 180 g of LUNA™ C18 (Phenomenex, Torrance, Calif.), a typical packing material used in preparative HPLC and compressed by dynamic axial compression at a pressure of 41 bar. The first column was packed according to the prior art, that is without axial vibration. For the second column, the slurry of packing material was poured into the column which was then vibrated at 60 Hz for 12 minutes during compression of the slurry into a bed. The third and fourth columns were packed following the same protocol as described for the second column but with vibration for 10 minutes at 90 Hz during consolidation of its bed. The amplitude of vibration was about 5 mm for column 2 and about 3 mm for columns 3 and 4. The duration of vibration of each of these columns lasted longer than the consolidation process.

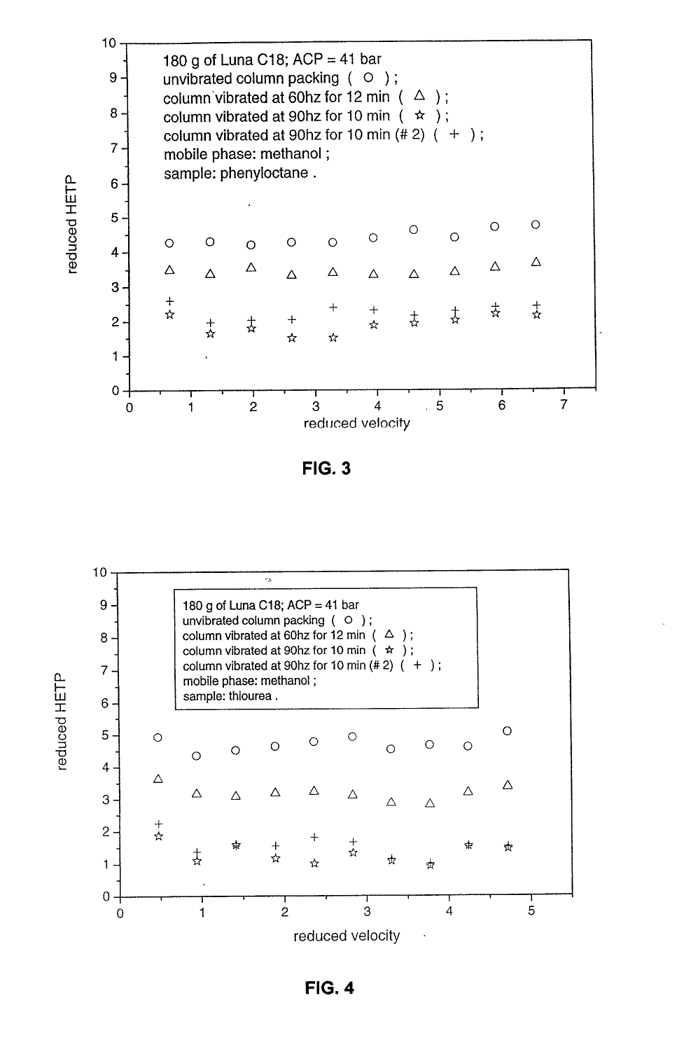

Following the packing of each column, a series of injections of a dilute sample of a solution of phenyloctane and thiourea in a methanol mobile phase were carried out. Each chromatogram was recorded at constant mobile phase velocity. The velocity was increased between each successive injection. The results are shown graphically in FIG. 3 for phenyloctane and in FIG. 4 for thiourea.

As shown in FIG. 3, there was a marked improvement of the efficiency of the column for phenyloctane at all flow velocities tested when vibrated at 60 Hz (triangles) compared to that of the column that had not been vibrated (circles). Vibration of each of the two columns at 90 Hz (plus signs and stars) produced a dramatic increase of the efficiency with values of h (reduced HETP) that are consistently below 2 and as low as about 1.4 in a wide range of flow velocities.

As shown in FIG. 4, there was also a marked improvement of the efficiency of the column for the unretained thiourea at all flow velocities tested when vibrated at 60 Hz (triangles) compared to that of the column that had not been vibrated (circles). Vibration of each of the two columns at 90 Hz (plus signs and stars) produced a dramatic increase of the efficiency with values of h consistently around 1.4 in a wide range of flow velocities, with values of h at some flow velocities approaching 1.0.

Although the above description contains many specificities, they should not be interpreted as limitations of the scope of the invention, but rather as illustrations. One skilled in the art will understand that many variations of the invention are possible and that these variations are to be included within the scope of the following claims.

1. A method for packing a chromatographic column comprising loading the column with a packing material and essentially eliminating the friction between the packing material and the inner wall of the chromatographic column.

2. The method of claim 1 wherein the elimination of friction is by vibrating the column in a direction substantially parallel to its long axis.

3. The method of claim 1 wherein the packing material is loaded into the column in the form of a slurry.

4. The method of claim 2 wherein the packing material is loaded into the column in the form of a slurry.

5. The method of claim 4 which further comprises axially compressing the packing material within the column.

6. The method of claim 5 wherein the vibration and the axial compression are performed together.

7. The method of claim 5 wherein the vibration is continued until a compacted bed of packing material is obtained.

8. The method of claim 5 wherein the vibration is started before compression of the bed of packing material is applied.

9. The method of claim 2 wherein the packing material is not axially compressed.

10. The method of claim 4 which further comprises percolating one or more column volumes of a packing solvent.

11. The method of claim 10 wherein the column is vibrated during the percolation of the packing solvent.

12. The method of claim 11 wherein the vibration of the column starts before the percolation of the packing solvent.

13. The method of claim 2 wherein the frequency of vibration of the column is between 1 and 1000 hertz.

14. The method of claim 13 wherein the frequency of vibration is between 60 and 120 hertz.

15. The method of claim 14 wherein the frequency of vibration is between 90 and 100 hertz.

16. The method of claim 1 wherein the packing material is loaded into the column as a dry mass of packing material.

17. The method of claim 16 wherein, after the dry packing material is loaded into the column, the packing material is wetted to obtain a slurry of packing material.

18. The method of claim 2 wherein the packing material is loaded into the column as a dry mass of packing material.

19. The method of claim 18 wherein, after the dry packing material is loaded into the column, the packing material is wetted to obtain a slurry of packing material.

20. A method for reducing friction between the interior surface of a chromatographic column and a bed of packing material contained within the column comprising vibrating the column in a direction substantially parallel to its length.

21. The method of claim 20 wherein the frequency of vibration of the column is between 1 and 1000 hertz.

22. The method of claim 21 wherein the frequency of vibration is between 60 and 120 hertz.

23. The method of claim 22 wherein the frequency of vibration is between 90 and 100 hertz.

24. The method of claim 20 wherein the vibration is during the process of packing the chromatographic column.

25. The method of claim 20 wherein the packing material is in the form of a slurry.

26. A packed chromatographic column in which the reduced HETP of the column is less than 2.

27. A packed chromatographic column containing a bed of packing material that is substantially radially homogenous.

28. A chromatographic column that has been packed according to the method of claim 2.

29. A chromatographic column that has been packed according to the method of claim 3.

30. A chromatographic column that has been packed according to the method of claim 13.

31. A method for separating one or more compounds from a mixture of compounds comprising inserting the mixture into one end of a chromatographic column that has been packed while being vibrated in a direction substantially parallel to its long axis and permitting the compounds to travel along the length of the column and exit at the opposite end of the column.

32. An apparatus for vibrating a chromatographic column comprising a holder for the chromatographic column and a vibrator that vertically oscillates the column, wherein the holder maintains the column in a substantially vertical direction during the oscillation.

33. The apparatus of claim 32 wherein the holder comprises a base and one or more horizontally extending support arms connected to the base for maintaining the column in a desired position.

34. The apparatus of claim 32 wherein the vibrator is a vibrating table upon which the holder is anchored.

35. The apparatus of claim 32 wherein the vibrator is an integral portion of the holder.
